(19) United States
(12) Patent Application Publication
(10) Pub. No.: US 2024/0300862 A1
(43) Pub. Date: Sep. 12, 2024

(54) DRY GRINDING OF CLAY MINERAL, GROUND CLAY MINERAL, AND ITS USE IN CONSTRUCTION MATERIALS

(71) Applicant: SIKA TECHNOLOGY AG, Baar (CH)

(72) Inventors: Jerome SOUDIER, Vaux En Bugey (FR); Olivier LEVESQUE, Crémieu (FR); Javier QUESADA, Madrid (ES); Joris GOUY-PAILLER, Lyon (FR); Ramiro GARCIA, Madrid (ES)

(73) Assignee: SIKA TECHNOLOGY AG, Baar (CH)

(21) Appl. No.: 18/283,873

(22) PCT Filed: Mar. 21, 2022
(86) PCT No.: PCT/EP2022/057372

§ 371 Date: Sep. 25, 2023

(30) Foreign Application Priority Data
Mar. 26, 2021 (EP) 21305383.8

(51) Int. Cl. C04B 40/00; C04B 14/10; C04B 24/06; C04B 24/10; C04B 24/12; C04B 103/52

(52) U.S. Cl. CPC C04B 40/0042; C04B 14/106; C04B 24/06; C04B 24/10; C04B 24/122; C04B 2103/52

(57) ABSTRACT

The use of a grinding additive during the dry grinding of clay mineral, wherein the grinding additive is selected from the group consisting of alkanolamines, glycols, glycerol, sugars, sugar acids, carboxylic acids or their salts, superplasticizers, superabsorbent polymers, or mixtures thereof. Construction materials also include a ground clay mineral including the additives and the use of the ground clay mineral.

### TECHNICAL FIELD

The present invention relates to the dry grinding of clay mineral in the presence of grinding additives selected from alkanolamines, glycols, glycerol, sugars, sugar acids, carboxylic acids or their salts, superplasticizers, superabsorbent polymers, or mixtures thereof. The present invention also relates to ground clay minerals comprising said additives and their use in construction materials.

### BACKGROUND

Cement-based building materials, especially concrete or mortars, rely on cementitious materials as binders. Cementitious binders typically are hydraulic binders the most abundant of which are cements and especially Ordinary Portland Cement (OPC). However, the use of cements and especially of Ordinary Portland Cement has a high environmental footprint. One major reason are the high CO₂ emissions associated with the manufacture of cements. Many efforts have thus been made to at least partially replace cements as binders from building materials.

One possibility is the use of materials with cementitious properties, pozzolanes and/or latent hydraulic materials as cement replacement. An especially appealing material of this kind are clay minerals as they are available naturally in large quantities.

Raw clay mineral typically is in the form of granules and, just like cement, needs to be ground in a compressive grinder or an attrition mill to obtain a powder product with a fineness suitable to be used in construction materials. Possible ways of grinding a clay mineral is by the use of a vertical roller mill or a ball mill. In a vertical roller mill, a compressive force on the clay mineral granules is exerted by rotating cylinders while in a ball mill the impact of balls on the granules leads to their disintegration. In any case a powder with defined fineness can be obtained. The grinding can be done in a dry state or in a wet state, e.g. where the clay mineral is suspended in water.

It also well known in the art of cement grinding or clay mineral grinding that various grinding additives can be used during grinding to improve the overall efficiency of the grinding process.

Dry grinding of clay mineral can be advantageous over wet grinding because the resulting ground clay mineral does not need to be additionally dried before being formulated for example in dry mortars.

WO98/21158 discloses a method for dry grinding of calcined kaolin clay in the presence of ammonium polyacrylate.

There is still a need for improved methods of grinding clay minerals. Specifically, the dry grinding of clay minerals needs to be improved.

### SUMMARY OF THE INVENTION

It is the objective of the present invention to provide methods for the dry grinding of clay minerals. Especially, the efficiency of the dry grinding of clay minerals is to be improved. It is also an object of the present invention to provide improved ground clay minerals which can be used to make construction materials.

Surprisingly, it has been found that the objectives of the present invention can be solved by the subject-matter of the independent claims.

Especially, the use of grinding additives selected from alkanolamines, glycols, glycerol, sugars, sugar acids, carboxylic acids or their salts, superplasticizers, superabsorbent polymers, or mixtures thereof, in the dry grinding of clay minerals leads to an improvement in grinding efficiency and to improved ground clay minerals comprising these additives.

The efficiency of the dry grinding of clay minerals, and especially of calcined clay minerals, can be improved by the use of said additives. Specifically, a higher Blaine surface of ground clay mineral is obtained when grinding is effected for the same time with said additives being present as compared to when no additives are present. Additionally, the amount of ground clay mineral sticking to grinding tools (e.g. balls and vessel of a ball mill) is significantly reduced when additives of the present invention were used.

It has also surprisingly been found that the use of a clay mineral dry ground in the presence of a grinding additive of the present invention improves the performance of a construction material comprising said clay mineral as compared to the same construction material comprising a clay mineral ground without said additives. Especially the early strength and/or the final strength of the construction material is improved when a clay mineral dry ground in the presence of a grinding additive is used.

Other aspects of the present invention are the subject of independent claims. Preferred embodiments of the present invention are the subject of dependent claims.

### WAYS OF CARRYING OUT THE INVENTION

Within the present context the terms milling and grinding have the same meaning and can be exchanged.

In a first aspect the present invention relates to the use of a grinding additive during the dry grinding of clay minerals, characterized in that the grinding additive is selected from the group consisting of alkanolamines, glycols, glycerol, sugars, sugar acids, carboxylic acids or their salts, superplasticizers, superabsorbent polymers, or mixtures thereof.

Clay minerals within the present context are solid materials composed to at least 30 w %, preferably to at least 35 w %, especially to at least 75 w %, each relative to its dry weight, of clay minerals. Such clay minerals preferably belong to the kaolin group (such as kaolinite, dickite, nacrite or halloysite), the smectite group (such as montmorillonite, nontronite or saponite), the vermiculite group, serpentine, palygorskite, sepiolite, chlorite, talc, pyrophyllite, micas (such as biotite muscovite, illite, glauconite, celadonite, and phengite) or mixtures thereof. Clay minerals belonging to the kaolin group, especially kaolinite, and micas, especially muscovite and illite, as well as mixtures thereof are especially preferred. Clay minerals within the present context can be any type of clay mineral, for example crude clays, low-temperature calcined clays, or high-temperature calcined clays. Crude clays are clay minerals extracted from e.g. a quarry, optionally purified and optionally dried. Low-temperature calcined clays are clays that have been thermally treated at temperatures between 500-1200° C. Such low-temperature calcination typically leads to removal of interlayer water and at least partial, preferably full, de-hydroxylation. For example, low-temperature calcined clay minerals may be produced in rotary kiln or in a flash calciner. High-temperature calcined clays are clay minerals that have been thermally treated at temperatures above 1200° C. and typically between 1300-1400° C. High-temperature calcined clays typically are crystalline or contain high amounts of crystalline phases, especially of mullite.

Clay minerals within the present context preferably are low-temperature calcined clays. A low-temperature calcined clay is a clay material that has been put to a heat treatment, preferably at a temperature between 500-1200° C., or in a flash calcination process at temperatures between 800-1100° C. A suitable flash calcination process is for example described in WO 2014/085538. A low-temperature calcined clay is an anhydrous material. It is preferred within the present context that during the calcination of clay the clay material is dehydroxylated to an amorphous material while the formation of crystalline high temperature aluminosilicate phases such as mullite is prevented. Low-temperature calcined clays, and especially low-temperature calcined kaolinite, generally are amorphous, have a significantly higher specific surface as compared to the original clay, and have a pozzolanic activity.

According to especially preferred embodiments of the present invention, the calcined clay is metakaolin. Metakaolin is a material resulting from the low-temperature calcination of kaolinite or minerals that are rich in kaolinite, e.g. have a content of kaolinite of at least 30 w %, preferably to at least 35 w %, relative to its dry weight. Calcination temperatures for the manufacturing of metakaolin typically are in the range of 500-900° C. Low-temperature calcined clays often are difficult to grind because they tend to stick to grinding tool and/or form agglomerates during grinding. Also, it is if interest to increase the reactivity of ground low-temperature calcined clays for use in construction materials.

The particle size of a clay mineral can be analyzed by sieve analysis as described for example in standard ASTM C136/C136M. The process separates fine particles from more course particles by passing the material through a number of sieves of different mesh sizes. The material to be analysed is vibrated through a series of sequentially decreasing sieves using a single, or combination of horizontal, vertical or rotational motion. As a result, the percentage of particles retained on a sieve of a given size is given.

Another measure for the fineness of a clay mineral is the Blaine surface. The Blaine surface can be determined according to NF EN 196-6.

The term “dry grinding” within the present context refers to a grinding operation where there is a very low content of water present or better essentially no water present. A very low content of water means that the water content during the grinding of a clay mineral is below 1 w %, preferably below 0.1 w %, more preferably equal to or below 0.06 w %, in each case relative to the total weight of the clay mineral. According to embodiments, the amount of water present during grinding is not higher than 1 w %, preferably 0.1 w %, more preferably 0.06 w %, relative to the total dry weight of the clay mineral

The grinding additive is selected from the group consisting of alkanolamines, glycols, glycerol, sugars, sugar acids, carboxylic acids or their salts, superplasticizers, superabsorbent polymers, or mixtures thereof.

Suitable alkanolamines are preferably selected from the group consisting of monoethanolamine, diethanolamine, triethanolamine (TEA), diethanolisopropanolamine (DEIPA), ethanoldiisopropanolamine (EDIPA), isopropanolamine, diisopropanolamine, triisopropanolamine (TIPA), N-methyldiisopropanolamine (MDIPA), N-methyldiethanolamine (MDEA), tetrahydroxyethylethylenediamine (THEED), and tetrahydroxyiso-propylethylenediamine (THIPD), as well as mixtures of two or more of these alkanolamines.

Especially preferred alkanolamines are TIPA, MDIPA, MDEA, DEIPA, EDIPA, THEED, and THIPD.

Examples of suitable glycols are monoethylene glycol, diethylene glycol, triethylene glycol, tetraethylene glycol, pentaethylene glycol, polyethylene glycol, in particular with 6 or more ethylene units, e.g. PEG 200, neopentyl glycol, hexylene glycol, propylene glycol, dipropylene glycol and polypropylene glycol. It is also possible to use mixtures of two or more different glycols as well as of at least one glycol and glycerol.

In one embodiment, the glycerol is a so-called bio-glycerol, which can be produced from a renewable raw material.

A “sugar” in the sense of the present invention is a carbohydrate having an aldehyde group. In particularly preferred embodiments, the sugar belongs to the group of monosaccharides or disaccharides. Examples of sugars include, but are not limited to, glyceraldehyde, threose, erythrose, xylose, lyxose, ribose, arabinose, allose, altrose, glucose, mannose, gulose, idose, galactose, tallose, fructose, sorbose, lactose, maltose, sucrose, lactulose, trehalose, cellobiose, chitobiose, isomaltose, palatinose, mannobiose, raffinose and xylobiose. Sugars can also be used in form of e.g. vinasse, molasse.

A “sugar acid” in the context of the present invention is a monosaccharide having a carboxyl group. It may belong to any of the classes of aldonic acids, ursonic acids, uronic acids or aldaric acids. Preferably, it is an aldonic acid. Examples of sugar acids useful in connection with the present invention include, but are not limited to, glyceric acid, xylon acid, gluconic acid, ascorbic acid, neuraminic acid, glucuronic acid, galacturonic acid, iduronic acid, tartaric acid, mucilic acid and saccharic acid. The sugar acid may be in the form of the free acid or as a salt. According to embodiments, salts of sugar acids may be salts with metals of groups Ia, IIa, Ib, IIb, IVb, VIIIb of the periodic table of elements. Preferred salts of sugar acids are salts of alkali metals, alkaline earth metals, iron, cobalt, copper or zinc. Especially preferred are salts with monovalent metals such as lithium, sodium and potassium.

The term “carboxylic acid” means any organic molecule with a carboxylate group, except sugar acids. Especially preferred carboxylic acids are oxalic acid, malonic acid, adipic acid, lactic acid, citric acid, and tartaric acid. The carboxylic acid may be in the form of the free acid or in the form of a salt. Thus, throughout the present invention, where reference is made to carboxylic acid or to a specific carboxylic acid, such reference is meant to encompass the fully protonated form of the respective carboxylic acid as well as any salts thereof. According to embodiments, salts of carboxylic acids may be salts with metals of groups Ia, IIa, Ib, IIb, IVb, VIIIb of the periodic table of elements. Preferred salts of sugar acids are salts of alkali metals, alkaline earth metals, iron, cobalt, copper or zinc. Especially preferred are sodium, potassium, or calcium salts of carboxylic acids, in particular sodium, potassium, or calcium salts of citric acid.

The term “superabsorbent polymers” refers to polymers that can absorb large amounts of water. When superabsorbent polymers come into contact with water, the water molecules diffuse into the cavities of the polymer network and hydrate the polymer chains. The polymer can thus swell and form a polymer gel or slowly dissolve. This step is reversible, so the superabsorbent polymers can be regenerated to their solid state by removing the water. The water absorption property is denoted by the swelling ratio, by which is meant the ratio of the weight of a swollen superabsorbent polymer to its weight in the dried state. The swelling ratio is influenced by the degree of branching of the superabsorbent polymer, any crosslinking that may be present, the chemical structure of the monomers that form the superabsorbent polymer network, and external factors such as the pH, ion concentration of the solution, and temperature. Because of their ability to interact with water, superabsorbent polymers are also referred to as hydrogels.

Examples of superabsorbent polymers useful in the context of the present invention include but are not limited to natural polymers, such as starch, cellulose, such as cellulose ether, chitosan or collagen, alginates, synthetic polymers, such as poly(hydroxyethyl methacrylate), poly(ethylene glycol) or poly(ethylene oxide) or ionic synthetic polymers, such as polyacrylic acid (PAA), polymethacrylic acid (PMAA), polyacrylamides (PAM), polylactic acid (PLA), polyethyleneimine, polyvinyl alcohol (PVA) or polyvinylpyrrolidone.

Superabsorbent polymers that are particularly suitable in the context of the present invention are ionic superabsorbent polymers, in particular those based on polyacrylamide modified with acrylic acid, which can be of either linear or crosslinked structure.

Superplasticizers useful as grinding additives especially are polycarboxylate ether and/or polycarboxylate ester (PCE).

PCEs of the present invention comprise
(i) Repeating units A of the general structure (I),

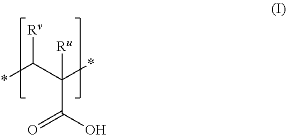

and
(ii) repeat units B of the general structure (II),

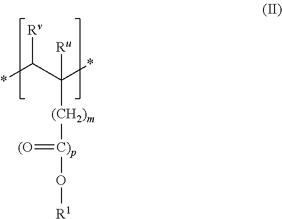

wherein
each Ru independently represents hydrogen or a methyl group,
each Rv independently represents hydrogen or COOM, wherein M independently is H, an alkali metal, or an alkaline earth metal,
m=0, 1, 2 or 3,
p=0 or 1
each R1 is independently-(CH2)z-[YO]n-R4, where Y is a C2 to C4 alkylene and R4 is H, C1 to C20 alkyl,-cyclohexyl,-alkylaryl, or a —N(-Ri)j-[(CH2)z-PO3M]3-j, z=0, 1, 2, 3, or 4 n=2-350, j=0, 1 or 2, Ri represents a hydrogen atom or an alkyl group having 1-4 carbon atoms, and M represents a hydrogen atom, an alkali metal, an alkaline earth metal or an ammonium ion,
and wherein the repeating units A and B in the PCE have a molar ratio of A:B in the range of 10: 90-90:10.

In a preferred embodiment, n=10-250, more preferably 30-200, particularly preferably 35-200, especially 40-110.

In a further preferred embodiment, z=0. In a further preferred embodiment, z=4.

In a particularly preferred embodiment, the PCE comprises repeating units A of the general structure (I) as well as repeating units B of the general structure (II), the molar ratios of A to B being in the range of 20: 80-80:20, more preferably 30: 70-80:20, in particular 35:65-75:25.

A PCE preferably has an average molar mass Mw in the range of 1,000-1,000,000, more preferably 1,500-500,000, most preferably 2,000-100,000, in particular 3,000-75,000 or 3,000-50,000 g/mol. The molar mass Mw is determined in the present case by gel permeation chromatography (GPC) with polyethylene glycol (PEG) as standard. This technique is known per se to the skilled person.

PCEs according to the invention can be random or non-random copolymers. Non-statistical copolymers are in particular alternating copolymers or block or gradient copolymers or mixtures thereof.

According to embodiments, the grinding additive is selected from triisopropanolamine (TIPA), triethanolamine (TEA), diethanolisopropanolamine (DEIPA), ethanoldiisopropanolamine (EDIPA), or mixtures of at least one of TIPA, TEA, DEIPA, and EDIPA with at least one of diethylene glycol, glycerol, carboxylic acid, and sugar.

According to preferred embodiments, the grinding additive is selected from the group consisting of triisopropanolamine (TIPA), triethanolamine (TEA), diethanolisopropanolamine (DEIPA), ethanoldiisopropanolamine (EDIPA), lactic acid, malonic acid, adipic acid, citric acid, galactose, glucose, lactose, maltose, sucrose, fructose, or mixtures thereof.

According to especially preferred embodiments, the grinding additive is selected from triisopropanolamine (TIPA), triethanolamine (TEA), diethanolisopropanolamine (DEIPA), or is a mixture of DEIPA with a sugar, or is a mixture of TIPA with a sugar, or is a mixture of DEIPA with a carboxylic acid, or is a mixture of TIPA with a carboxylic acid. The sugar being preferably galactose, glucose, lactose, maltose, sucrose, or fructose. According to embodiments, where the grinding additive is a mixture of DEIPA or of TIPA with a sugar, preferably galactose, glucose, lactose, maltose, sucrose, or fructose, the weight ratio of DEIPA or TIPA:sugar is 1:1.

Especially preferred embodiments of the present invention are the use of a grinding additive selected from TIPA, TEA, DEIPA, EDIPA, lactic acid, malonic acid, adipic acid, citric acid, galactose, glucose, lactose, maltose, sucrose, fructose, or mixtures thereof, preferably selected from triisopropanolamine (TIPA), triethanolamine (TEA), diethanolisopropanolamine (DEIPA), or a mixture of DEIPA with a sugar, or a mixture of TIPA with a sugar, or a mixture of DEIPA with a carboxylic acid, or a mixture of TIPA with a carboxylic acid, for the dry grinding of clay mineral.

Grinding additives may be added to the clay mineral before and/or during grinding in a total amount of between 0.001-3 w %, preferably 0.002-1 w %, more preferably 0.01-0.1 w %, in each case relative to the total dry weight of the clay mineral.

It is preferred that fines and/or the powdery material are removed from the grinding zone during grinding. This increases grinding efficiency. The removal preferably is done continuously, for example by blowing air through the grinding zone.

The method of the present invention may additionally comprise a step of separating the ground clay mineral according to particle size. According to embodiments, separation is effected at a predefined cut-off particle size in order to retrieve ground clay mineral with a particle size of at least the predefined cut-off particle size and/or in order to retrieve ground clay mineral with a particle size below the predefined cut-off particle size. According to further embodiments, it is also possible to separate the ground clay mineral into fractions of different particle size.

According to embodiments, separation is done by filtration, sieving, sedimentation, density separation, wind sifting, e.g. in cyclones, and/or centrifugation.

The method of the present invention can be done in a batch process or in a continuous process. Installations, especially grinders and mills, useful for the practice of the present invention are not particularly limited and are known per se. According to embodiments, the grinding is done in an attrition mill or a compressive grinder, especially in a ball mill or in a vertical roller mill. However, other mill types such as for example hammer mills, pebble mills, cone mills, E-mills, or jaw crushers are likewise suitable.

According to embodiments, dry grinding of the clay mineral is done in a ball mill with steel balls of a diameter between 0.5-3 mm. A weight ratio of clay mineral:steel balls is between 1:1 and 20:1. The time for dry grinding may vary between 1 minute and 3 hours, preferably 5 minutes and 1 hour, especially 10-30 minutes.

In a second aspect the present invention also relates to a ground clay mineral obtained by dry grinding a clay mineral in the presence of a grinding additive selected form the group consisting of alkanolamines, glycols, glycerol, sugars, sugar acids, carboxylic acids or their salts, superplasticizers, superabsorbent polymers, or mixtures thereof.

It is to be understood that all features and embodiments described above as being preferred also relate to the ground clay mineral.

In some embodiments, the present invention thus relates to a ground clay mineral obtained by dry grinding a clay mineral in the presence of a grinding additive selected from TIPA, TEA, DEIPA, EDIPA, lactic acid, malonic acid, adipic acid, citric acid, galactose, glucose, lactose, maltose, sucrose, fructose, or mixtures thereof, preferably selected from triisopropanolamine (TIPA), triethanolamine (TEA), diethanolisopropanolamine (DEIPA), or a mixture of DEIPA with a sugar, or a mixture of TIPA with a sugar, or a mixture of DEIPA with a carboxylic acid, or a mixture of TIPA with a carboxylic acid.

According to embodiments, the clay mineral is a metakaolin and the grinding additive is selected from triisopropanolamine (TIPA), triethanolamine (TEA), diethanolisopropanolamine (DEIPA), or is a mixture of DEIPA with a sugar, or is a mixture of TIPA with a sugar, or is a mixture of DEIPA with a carboxylic acid, or is a mixture of TIPA with a carboxylic acid

It is preferred that the ground clay mineral obtained as explained above has a Blaine surface which is higher than the one of the clay mineral prior to grinding.

According to embodiments, the calcined clay is ground to a powder with a 45 μm residue as measured according to ASTM C136/C136M of at least 0.5 w %, preferably at least 2 w %, still more preferably at least 10 w %, especially at least 20 w %. Preferably, the 45 μm residue of a ground clay of the present invention is not more than 50 w %.

In a third aspect the present invention relates to a construction material, especially a mortar or concrete, comprising a ground clay mineral as described above.

The ground clay mineral of the present invention is used in the construction material as binder, as part of the binder, and/or as an aggregate. Preferably, the construction material of the present invention additionally comprises at least one mineral binder and optionally further aggregates. Preferably, the at least one mineral binder is selected from the group consisting of cement, gypsum, lime, latent hydraulic binders, pozzolanes, and geopolymers. Cements can in particular be Portland cements as described in standard EN 197-1, calcium aluminate cements as described in standard EN 14647, and/or calcium sulfoaluminate cements. The term “gypsum” is meant to encompass CaSO₄ in various forms, in particular CaSO₄ anhydrite, CaSO₄ α- and β-hemihydrate, and CaSO₄ dihydrate. The term “lime” is meant to encompass natural hydraulic lime, formulated lime, hydraulic lime, and air lime as described in the standard EN 459-1:2015. Pozzolanes and latent hydraulic materials preferably are selected from the group consisting of slag such as ground granulated blast furnace slag (GGBS), convertor slag or basic oxygen furnace slag (BOF-slag), kiln dust, microsilica, fly ash, sodo-calcic glass, boro-calcic glass, recycled glass, zeolite, rice husk ash, burnt oil shale, and natural pozzolane such as pumice and trass. Geopolymers are alumo-siliceous polymers. One particular example of a geopolymer is clay mineral activated with water glass.

Construction materials within the present context optionally comprise further aggregates. Aggregates can be any material that is non-reactive in the hydration reaction of hydraulic binders. Aggregates can be any aggregate typically used for construction materials. Typical aggregates are for example rock, crushed stone, gravel, sand, especially quartz sand, river sand and/or manufactured sand, recycled concrete, slag, glass, expanded glass, hollow glass beads, glass ceramics, volcanic rock, pumice, perlite, vermiculite, quarry wastes, porcelain, electrofused or sintered abrasives, firing support, silica xerogels. Aggregates may also be fine aggregates or fillers such as ground limestone, ground dolomite, and/or ground aluminum oxide. Aggregates useful for the present invention can have any shape and size typically encountered for such aggregates. An especially preferred aggregate is sand. Sand is a naturally occurring granular material composed of finely divided rock or mineral particles. It is available in various forms and sizes. Examples of suitable sands are quartz sand, limestone sand, river sand or crushed aggregates. Suitable sands are for example described in standards ASTM C778 or EN 196-1.

According to embodiments, aggregates can also be one or more of the following (i)-(v): (i) biosourced materials, preferably of plant origin, more preferably biosourced materials of plant origin essentially composed of cellulose and/or lignin, especially biosourced materials selected from the group comprising or consisting of hemp, flax, cereal straw, oats, rice, rape, maize, sorghum, flax, miscanthus, rice husk, sugar cane, sunflower, kenaf, coconut, olive stones, bamboo, wood, or mixtures thereof. According to embodiments, biosourced materials of plant origin have a defined form which is preferably selected from fibres, fibrils, dust, powders, shavings, pith, in particular pith of sunflower, maize, rape, and mixtures thereof.

(ii) synthetic non-mineral materials, preferably selected from the group comprising or consisting of thermoplastic, thermosetting plastics, elastomers, rubbers, textiles fibers, plastic materials reinforced with glass or carbon fibres. Synthetic non-mineral materials can be filled or unfilled.

(iii) aggregates of inorganic nature from the deconstruction of civil engineering or building structures, preferably selected from the group comprising or consisting of waste concrete, mortar, bricks, natural stone, asphalt, tiles, tiling, aerated concrete, clinker, scrap metal.

(iv) aggregates of organic nature from the recycling of industrial products, in particular composite materials which are difficult to recycle, especially recycled insulating materials. Especially preferred examples are polystyrenes, polyurethanes, phenolic resins, wood insulating materials, and mixtures thereof.

(v) non-hazardous granular materials usually destined for landfill such as used slags, foundry sands, catalyst supports, Bayer process de-soding treatment supports, clinker aggregates, fillers from the treatment of excavation sludge, sewage sludge, slurry, paper waste, paper incineration ashes, household waste incineration ashes.

Most preferably, aggregates are in particulate form.

Optionally, a construction material of the present invention may additionally comprise least one additive selected from the group consisting of plasticizers, superplasticizers, shrinkage reducers, air entrainers, de-aerating agents, stabilizers, viscosity modifiers, water reducers, accelerators, retarders, water resisting agents, strength enhancing additives, fibres, blowing agents, defoamers, redispersible polymer powders, chromate reducers, pigments, and steel passivating agents.

A construction material of the present invention can be in a dry state. Typically, dry construction materials are in the form of powders. A dry construction material can especially be a dry mortar or a dry concrete. Dry construction materials preferably have a water content of not more than 5 w %, more preferably not more than 2 w %, especially not more than 1 w %, in each case relative to the total weight of binder present in the dry construction material.

A construction material of the present invention can also be in the wet state. Typically, wet construction materials are in the form of slurries in water. A wet construction material can especially be a dry mortar or dry concrete mixed with water. Wet construction materials preferably have a mass ratio of water:mineral binder between 0.1-0.8, preferably 0.25-0.6, especially 0.3-0.5.

A construction material of the present invention can also be in the hardened state. Hardening of a dry construction material of the present invention starts when water is added. Upon hardening the construction material attains its final strength. A hardened construction material can have any desired form. A hardened construction material can be a building or be part of a building.

Especially, a construction material can be a dry concrete or a dry mortar.

According to an especially preferred embodiment, the ground clay mineral is combined into a binder with Ordinary Portland Cement and limestone to be used in a construction material.

A particularly preferred binder of such type comprises
a) 25-100 mass parts of Portland cement,
b) 3-50 mass parts of clay mineral, preferably of calcined clay, especially of metakaolin,
c) 5-100 mass parts of limestone.

Another preferred binder of such type comprises
92-99 w %, relative to the total dry weight of the binder composition, of a mixture of
a) 25-100 mass parts of Portland cement,
b) 3-50 mass parts of clay mineral, preferably of calcined clay, especially of metakaolin,
c) 5-100 mass parts of limestone, and
1-8 w %, relative to the total dry weight of the binder composition, of calcium sulfate.

A construction material of the present invention comprises or consists of (in each case relative to the total dry mass of the construction material)
a) 1-99 w % of a ground clay mineral as described above;
b) 1-99 w % of at least one mineral binder, preferably selected from the group consisting of cement, gypsum, lime, latent hydraulic binders, pozzolanes, and geopolymers;
c) optionally 15-85 w % of aggregates;
d) optionally 0.1-10 w % of further additives; and
e) optionally water in an amount to realize a mass ratio of water:mineral binder between 0.1-0.8, preferably 0.25-0.6, especially 0.3-0.5.

According to embodiments, a construction material of the present invention comprises
a) 5-75 w %, preferably 6-20 w % or 25-75 w % of a ground clay mineral as described above;
b) 1-75 w %, preferably 5-50 w % of at least one mineral binder, preferably selected from the group consisting of cement, gypsum, lime, latent hydraulic binders, pozzolanes, and geopolymers;
c) 15-85 w % of aggregates;
d) optionally 0.1-10 w % of further additives; and
e) optionally water in an amount to realize a mass ratio of water:mineral binder between 0.1-0.8, preferably 0.25-0.6, especially 0.3-0.5.

According to further embodiments, a construction material of the present invention consists of
a) 5-75 w %, preferably 6-20 w % or 25-75 w % of a ground clay mineral as described above;
b) 1-75 w %, preferably 5-50 w % of at least one mineral binder, preferably selected from the group consisting of cement, gypsum, lime, latent hydraulic binders, pozzolanes, and geopolymers;
c) 15-85 w % of aggregates;
d) optionally 0.1-10 w % of further additives; and
e) optionally water in an amount to realize a mass ratio of water:mineral binder between 0.1-0.8, preferably 0.25-0.6, especially 0.3-0.5.

According to further embodiments, a construction material of the present invention comprises
a) 5-75 w %, preferably 6-20 w % or 25-75 w % of a ground clay mineral as described
above;
b) 1-75 w %, preferably 5-50 w % of Portland cement;
c) 15-85 w % of aggregates;
d) optionally 0.1-10 w % of further additives; and
e) optionally water in an amount to realize a mass ratio of water:mineral binder between 0.1-0.8, preferably 0.25-0.6, especially 0.3-0.5.

In a fourth aspect the present invention relates to a method to increase the efficiency of the dry grinding of clay mineral, characterized in that the clay mineral is dry ground together with an additive selected from triisopropanolamine (TIPA), triethanolamine (TEA), diethanolisopropanolamine (DEIPA), ethanoldiisopropanolamine (EDIPA), lactic acid, malonic acid, adipic acid, citric acid, galactose, glucose, lactose, maltose, sucrose, fructose, or mixtures thereof, preferably selected from triisopropanolamine (TIPA), triethanolamine (TEA), diethanolisopropanolamine (DEIPA), or a mixture of DEIPA with a sugar, or a mixture of TIPA with a sugar, or a mixture of DEIPA with a carboxylic acid, or a mixture of TIPA with a carboxylic acid and that the additive is added to the clay mineral prior and/or during grinding.

An increase in dry grinding efficiency is for example a shorter grinding time needed to obtain a given Blaine surface of the ground clay mineral. The Blaine surface can be measured as described above. An increase in dry grinding efficiency for example also is a lower amount of material sticking to parts of the mill during and after the grinding.

Thus, the present invention relates to a method to increase the efficiency of the dry grinding of clay mineral, said method comprising the steps of
(i) providing a clay mineral as described above,
(ii) providing an additive selected from triisopropanolamine (TIPA), triethanolamine (TEA), diethanolisopropanolamine (DEIPA), ethanoldiisopropanolamine (EDIPA), lactic acid, malonic acid, adipic acid, citric acid, galactose, glucose, lactose, maltose, sucrose, fructose, or mixtures thereof, preferably selected from triisopropanolamine (TIPA), triethanolamine (TEA), diethanolisopropanolamine (DEIPA), or a mixture of DEIPA with a sugar, or a mixture of TIPA with a sugar, or a mixture of DEIPA with a carboxylic acid, or a mixture of TIPA with a carboxylic acid,
(iii) dry grinding said clay mineral, and
(iv) intermixing said additive with said clay mineral prior to and/or during step (iii).

All features and embodiments described as preferred above also apply to this aspect. Especially, preferably, the clay mineral is a low-temperature calcined clay mineral.

In a fifth aspect the present invention relates to a method to increase the early strength and/or the final strength of a construction material comprising a ground clay mineral, characterized in that an additive is added to a clay mineral prior and/or during the grinding of said clay mineral and characterized in that the additive is selected from triisopropanolamine (TIPA), triethanolamine (TEA), diethanolisopropanolamine (DEIPA), ethanoldiisopropanolamine (EDIPA), lactic acid, malonic acid, adipic acid, citric acid, galactose, glucose, lactose, maltose, sucrose, fructose, or mixtures thereof, preferably selected from triisopropanolamine (TIPA), triethanolamine (TEA), diethanolisopropanolamine (DEIPA), or is a mixture of DEIPA with a sugar, or is a mixture of TIPA with a sugar, or is a mixture of DEIPA with a carboxylic acid, or is a mixture of TIPA with a carboxylic acid. There is no step of completely extracting the grinding additive from the ground clay mineral after the dry grinding.

The early strength relates to the compressive strength and/or flexural strength of a construction material after hardening for not more than 7 days, preferably after hardening for 1 day, 2 days, and/or 3 days. The final strength relates to the compressive strength and/or flexural strength of a construction material after hardening for 28 days. Compressive strength can be measured according to standard EN 12190 on 4×4×16 cm prisms. Flexural strength can be measured according to standard EN 196-1 on prisms 40×40×160 mm.

In particular, the early strength and/or final strength of a construction material comprising a ground clay mineral of the present invention is improved over the same construction material but comprising a ground clay mineral with the same Blaine surface and/or particle size and ground without the addition of an additive of the present invention.

Thus, the present invention relates to a method to increase the early strength and/or final strength of a cementitious material comprising a ground clay mineral, said method comprising the steps of
(i) providing a ground clay mineral as described above,
(ii) intermixing said ground clay mineral with at least one mineral binder,
(iii) optionally intermixing the mixture obtained in step (ii) with aggregates and further additives, and
(iv) optionally intermixing the mixture obtained in step (ii) or (iii) with water.

All features and embodiments described as preferred above also apply to this aspect. Especially, preferably, the clay mineral is a low-temperature calcined clay mineral.

According to particular embodiments, the method is characterized in that the ground clay mineral comprises an additive selected from triisopropanolamine (TIPA), triethanolamine (TEA), diethanolisopropanolamine (DEIPA), ethanoldiisopropanolamine (EDIPA), or mixtures of at least one of TIPA, TEA, DEIPA, and EDIPA with at least one of diethylene glycol, glycerol, carboxylic acid, and sugar, preferably from triisopropanolamine (TIPA), triethanolamine (TEA), diethanolisopropanolamine (DEIPA), ethanoldiisopropanolamine (EDIPA), lactic acid, malonic acid, adipic acid, citric acid, galactose, glucose, lactose, maltose, sucrose, fructose, or mixtures thereof, more preferably selected from triisopropanolamine (TIPA), triethanolamine (TEA), diethanolisopropanolamine (DEIPA), or a mixture of DEIPA with a sugar, or a mixture of TIPA with a sugar, or a mixture of DEIPA with a carboxylic acid, or a mixture of TIPA with a carboxylic acid, which additive was added to said clay mineral prior and/or during the grinding of said clay mineral.

The following examples will provide the person skilled in the art with further details and embodiments of the present invention.

### EXAMPLES

The following table 1 shoes an overview of the raw materials used.

TABLE 1
raw materials

| | |
|---|---|
| Clay Type 1 | Low-temperature calcined clay (kaolinitc); 46.8% SiO₂, 31.9% Al₂O₃, |
| | 5.6% Fe₂O₃, 2.1% TiO₂, 0.4% MgO, 0.3% CaO, 0.1% K₂O, 0.1% Na₂O |
| Clay Type 2 | Low-temperature calcined clay (kaolinitc); 52.4% SiO₂, 25.6% Al₂O₃, |
| | 9.7% Fe₂O₃, 1.4% TiO₂, 1% K₂O, 0.3% MgO, 0.2% CaO, 0.1% Na₂O |
| Clay Type 3 | Low-temperature calcined clay (kaolinitc); 54.2% SiO₂, 29.5% Al₂O₃, |
| | 3.4% Fe₂O₃, 1% TiO₂, 0.6% K₂O, 0.3% MgO, 0.2% CaO, 0.1% Na₂O |
| Clay Type 4 | Low-temperature calcined clay (kaolinitc); 65.9% SiO₂, 19.1% Al₂O₃, |
| | 3.9% Fe₂O₃, 2% TiO₂, 0.7% MgO, 0.2% CaO, 0.1% K₂O, 0.1% Na₂O |
| Clay Type 5 | Calcined clay (kaolinitc); 50.8% SiO₂, 45.9% Al₂O₃, 1.2% TiO₂, 0.7% |
| | Fe₂O₃, 0.2% CaO, 0.15% K₂O, 0.14% MgO, 0.1% Na₂O |
| Clay Type 6 | Calcined clay (kaolinitc); 64.7% SiO₂, 23.6% Al₂O₃, 5.8% Fe₂O₃, 2.9% |
| | K₂O, 1% TiO₂, 0.5% MgO, 0.2% CaO, 0.2% Na₂O |
| TIPA | Triisopropanolamine, Sigma-Aldrich, 95% purity |
| TEA | Triethanolamine, Sigma-Aldrich, >99% purity |
| DEIPA | Diethanolisopropanolamine, Sigma-Aldrich, 94% purity |
| Citric Acid | Sigma-Aldrich, 99% purity |
| Fructose | D-(−)-Fructose, Sigma-Aldrich, >99% purity |

Measurement of Blaine surface was done according to standard NF EN 196-6.

Sieve analysis was done according to standard ASTM C136/C136M.

Determination of amount of material sticking to balls and vessel was determined by weighing.

Compressive strength was measured according to EN 12190 on 4×4×4 cm prisms after curing at 23° C./50% r.h. of a mixture consisting of 50 w % clay milled as per the respective example, 50 w % of slaked lime and mixed with water in a weight ratio of water:powder of 0.64 for 7d and 28d respectively.

### Example 1

90 g of the respective clay material as indicated in below table 2 were heated to 100° C. and were then charged into a ball mill. 260 g of steel balls were then added (vessel and balls were pre-heated to 100° C.). Then the respective grinding additives as shown in the following table 2 were added in an amount of 0.015 w % relative to the weight of the clay. All grinding additives were diluted with water prior to addition in an amount to introduce 0.06 w % of water relative to the clay. In case where a mixture of two grinding additives was used, each of the grinding additives was introduced in an amount of 0.015 w % relative to the weight of the clay and the mixture was diluted in water prior to addition in an amount to introduce 0.06 w % of water relative to the clay.

Milling was then effected for 5 minutes. After this time, a sample was taken for the analysis of Blaine surface and milling was continued for another 5 minutes. After the total milling time of 10 minutes, the Blaine surface of the resulting clay was measured, and the amount of material sticking to the balls and vessel was determined.

The following table 2 gives an overview of the results. Examples 1, 5, 9, 13, 17, and 24 are comparative examples not according to the invention.

TABLE 2
Results

| | 1 | 2 | 3 | 4 | 5 | 6 | 7 | 8 |
|---|---|---|---|---|---|---|---|---|
| Clay type | 1 | 1 | 1 | 1 | 2 | 2 | 2 | 2 |
| Grinding | None | TIPA | DEIPA | TEA | None | TIPA | DEIPA | TEA |
| additive type | | | | | | | | |
| Blaine @ 5 min | 9000 | 9230 | 9360 | 9250 | 8030 | 9210 | 9550 | 9600 |
| [g/cm²] | | | | | | | | |
| Blaine @ 10 min | 10000 | 11330 | 10540 | 10860 | 10000 | 10390 | 10700 | 10230 |
| [g/cm²] | | | | | | | | |
| Residue on | 47 | 36 | 34 | 34 | 45 | 34 | 36 | 34 |
| 45 μm sieve [%] | | | | | | | | |
| Residue on | 56 | 50 | 49 | 50 | 55 | 49 | 51 | 52 |
| 32 μm sieve [%] | | | | | | | | |
| Material | 30.9 | 10.1 | 6.8 | 7.6 | 24.3 | 6.8 | 6.3 | 5.6 |
| sticking^{*1} [%] | | | | | | | | |
| Compressive | 4 | 4.1 | 4.7 | 4.3 | 3.2 | 4.5 | 3.3 | 3.9 |
| strength 7 d | | | | | | | | |
| [MPa] | | | | | | | | |
| Compressive | 8.6 | 9.2 | 11.3 | n.m. | 8.9 | 12.6 | 11.3 | 11.3 |
| strength 28 d | | | | | | | | |
| [MPa] | | | | | | | | |
| | 9 | 10 | 11 | 12 | 13 | 14 | 15 | 16 |
| Clay type | 3 | 3 | 3 | 3 | 4 | 4 | 4 | 4 |
| Grinding | None | TIPA | DEIPA | TEA | None | TIPA | DEIPA | TEA |
| additive type | | | | | | | | |
| Blaine @ 5 min | 4760 | 6500 | 6250 | 6140 | 7320 | 8150 | 7960 | 7800 |
| [g/cm²] | | | | | | | | |
| Blaine @ 10 min | 6690 | 8080 | 8110 | 8380 | 8920 | 9140 | 9390 | 9500 |
| [g/cm²] | | | | | | | | |
| Residue on | 45 | 35 | 34 | 33 | 40 | 35 | 35 | 35 |
| 45 μm sieve [%] | | | | | | | | |
| Residue on | 58 | 51 | 50 | 49 | 51 | 49 | 48 | 49 |
| 32 μm sieve [%] | | | | | | | | |
| Material | 22.7 | 7 | 8.1 | 7.7 | 13.3 | 5.9 | 6.4 | 6.4 |
| sticking^{*1} [%] | | | | | | | | |
| Compressive | 3.6 | 4.5 | 4.7 | 4.8 | 2.3 | 2.5 | 2.7 | 2.6 |
| strength 7 d | | | | | | | | |
| [MPa] | | | | | | | | |
| Compressive | 9.6 | 11.5 | 10.1 | 11.4 | 5.5 | 6.1 | 6.3 | 5.9 |
| strength 28 d | | | | | | | | |
| [MPa] | | | | | | | | |

| | 17 | 18 | 19 | 20 | 21 | 22 | 23 |
|---|---|---|---|---|---|---|---|
| Clay type | 5 | 5 | 5 | 5 | 5 | 5 | 5 |
| Grinding | None | TIPA | DEIPA | TIPA & | TIPA & | DEIPA & | DEIPA & |
| additive type | | | | Citric Acid | Fructose | Citric Acid | Fructose |
| Blaine @ 5 min | 3910 | 6870 | 8110 | 6610 | 7060 | 6350 | 7180 |
| [g/cm²] | | | | | | | |
| Blaine @ 10 min | 5370 | 11090 | 11640 | 10690 | 11280 | 10540 | 10320 |
| [g/cm²] | | | | | | | |
| Residue on | 57 | 30 | 33 | 28 | 25 | 34 | 23 |
| 45 μm sieve [%] | | | | | | | |
| Residue on | 76 | 59 | 58 | 59 | 57 | 59 | 54 |
| 32 μm sieve [%] | | | | | | | |

| | 24 | 25 | 26 | 27 | 28 | 29 | 30 |
|---|---|---|---|---|---|---|---|
| Clay type | 6 | 6 | 6 | 6 | 6 | 6 | 6 |
| Grinding | None | TIPA | DEIPA | TIPA & | TIPA & | DEIPA & | DEIPA & |
| additive type | | | | Citric Acid | Fructose | Citric Acid | Fructose |
| Blaine @ 5 min | n.m. | 7830 | 7240 | 7470 | 7690 | 6970 | 7730 |
| [g/cm²] | | | | | | | |
| Blaine @ 10 min | 7670 | 9520 | 10230 | 9420 | 9530 | 9050 | 9140 |
| [g/cm²] | | | | | | | |
| Residue on | 17 | 13 | 13 | 14 | 16 | 15 | 12 |
| 45 μm sieve [%] | | | | | | | |
| Residue on | 40 | n.m. | 29 | 31 | 31 | 31 | 32 |
| 32 μm sieve [%] | | | | | | | |

n.m.: not measured

It can be seen from the above results that the various grinding additives tested are effective in increasing the fineness of clay minerals during grinding and/or reduce the grinding time needed to reach to a given fineness. The various grinding additives are also efficient in reducing the stickiness of material during grinding and/or of ground material. Finally, the various grinding additives tested are helpful to increase the compressive strength of a binder composition comprising the ground clay mineral and containing the respective grinding additive.

1-16. (canceled)

17. A method to increase the efficiency of dry grinding of clay mineral, the method comprising dry grinding the clay mineral together with an additive selected from triisopropanolamine (TIPA), triethanolamine (TEA), diethanolisopropanolamine (DEIPA), ethanoldiisopropanolamine (EDIPA), lactic acid, malonic acid, adipic acid, citric acid, galactose, glucose, lactose, maltose, sucrose, fructose, or mixtures thereof.

18. The method according to claim 17, wherein the clay mineral is a low-temperature calcined clay.

19. The method according to claim 17, wherein the additive is selected from triisopropanolamine (TIPA), triethanolamine (TEA), diethanolisopropanolamine (DEIPA), ethanoldiisopropanolamine (EDIPA), or mixtures of at least one of TIPA, TEA, DEIPA, and EDIPA with at least one of diethylene glycol, glycerol, carboxylic acid, and sugar.

20. The method according to claim 17, wherein the additive is selected from triisopropanolamine (TIPA), triethanolamine (TEA), diethanolisopropanolamine (DEIPA), or is a mixture of DEIPA with a sugar, or is a mixture of TIPA with a sugar, or is a mixture of DEIPA with a carboxylic acid, or is a mixture of TIPA with a carboxylic acid.

21. The method according to claim 17, wherein the additive is a mixture of DEIPA or TIPA with a sugar, and the weight ratio of DEIPA or TIPA:sugar is 1:1.

22. The method according to claim 17, wherein the additive is a mixture of DEIPA or TIPA with citric acid.

23. The method according to claim 17, wherein an amount of water present during grinding is not higher than 1 w %, relative to a total dry weight of the clay mineral.

24. The method as claimed in claim 17, wherein the additive is added to the clay mineral before and/or during grinding in a total amount of between 0.001-3 w %, in each case relative to a total dry weight of the clay mineral.

25. The method as claimed in claim 17, wherein the grinding is done in an attrition mill or a compressive grinder.

26. A ground clay mineral obtained by dry grinding a clay mineral in the presence of a grinding additive selected form the group consisting of alkanolamines, glycols, glycerol, sugars, sugar acids, carboxylic acids or their salts, superplasticizers, superabsorbent polymers, or mixtures thereof.

27. The ground clay mineral according to claim 26, wherein the clay mineral is a calcined clay, and the grinding additive is selected from triisopropanolamine (TIPA), triethanolamine (TEA), diethanolisopropanolamine (DEIPA), or is a mixture of DEIPA with a sugar, or is a mixture of TIPA with a sugar, or is a mixture of DEIPA with a carboxylic acid, or is a mixture of TIPA with a carboxylic acid.

28. A construction material comprising the ground clay mineral as claimed in claim 26.

29. The construction material as claimed in claim 28 comprising
a) 5-95 w % of a ground clay mineral obtained by dry grinding a clay mineral in the presence of a grinding additive selected form the group consisting of alkanolamines, glycols, glycerol, sugars, sugar acids, carboxylic acids or their salts, superplasticizers, superabsorbent polymers, or mixtures thereof;
b) 5-95 w % of at least one mineral binder selected from the group consisting of cement, gypsum, lime, latent hydraulic binders, pozzolanes, and geopolymers;
c) optionally 15-85 w % of aggregates;
d) optionally 0.1-10 w % of further additives; and
e) optionally water in an amount to realize a mass ratio of water:mineral binder between 0.1-0.8.

30. A method to increase the early strength and/or final strength of a cementitious material comprising a ground clay mineral, the method comprising
(i) providing the ground clay mineral as claimed in claim 26,
(ii) intermixing the ground clay mineral with at least one mineral binder,
(iii) optionally intermixing the mixture obtained in step (ii) with aggregates and further additives, and
(iv) optionally intermixing the mixture obtained in step (ii) or (iii) with water.

31. The method as claimed in claim 30, wherein the ground clay mineral comprises an additive selected from selected from triisopropanolamine (TIPA), triethanolamine (TEA), diethanolisopropanolamine (DEIPA), ethanoldiisopropanolamine (EDIPA), or mixtures of at least one of TIPA, TEA, DEIPA, and EDIPA with at least one of diethylene glycol, glycerol, carboxylic acid, and sugar, or mixtures thereof,
which additive was added to the clay mineral prior and/or during the grinding of the clay mineral.
